(19) United States
(12) Patent Application Publication
(10) Pub. No.: US 2010/0327534 A1
(43) Pub. Date: Dec. 30, 2010

(54) MAGNETIC BRUSH SEAL SYSTEM

(75) Inventors: Shridhar R. Powar, Bangalore Karnataka (IN); Shubhra Bhatnagar, Bangalore, Karnataka (IN)

Correspondence Address: SUTHERLAND ASBILL & BRENNAN LLP, 999 PEACHTREE STREET, N.E., ATLANTA, GA, 30309, US

(73) Assignee: General Electric Company, Schnectady, NY (US)

(21) Appl. No.: 12/492,243

(22) Filed: Jun. 26, 2009

(51) Int. Cl. F16J 15/53

(52) U.S. Cl. 277/355; 277/302

(57) ABSTRACT

A magnetic brush seal system for use with a rotating component and a stationary component. The magnetic brush seal system may include a brush seal for engagement with the rotating component and a magnetic system positioned about the stationary component. The magnetic system may he in communication with the brush seal so as to retract the brush seal from the rotating component.

### TECHNICAL FIELD

The present application relates generally to turbine engines and more particularly relates to the use of a retractable magnetic brush seal system for use with a turbine rotor or other types of components.

### BACKGROUND OF THE INVENTION

Brush seals are commonly used to eliminate or minimize air leakage through a gap between parts or components that may be positioned adjacent to each other. For example, brush seals are commonly used in rotating mechanisms such as steam or gas turbines used for power generation and the like. Typically, the brush seals minimize the leakage between regions at different pressures on opposite sides of the seal. As a specific example, a brush seal may be used to minimize air leakage between a stationary component such as a casing or a sealing ring and a rotating component such as a rotor of the turbine.

Brush seals, however, may wear out due to the fact that they have a tendency to rub against the rotor or other type of rotating surface during transient operations. Moreover, the brush seal may pinch onto the rotor and possibly damage the bristles of the brush seal. Thermally actuated brush seals have been used so as to avoid or limit, this pinching during transient operations. These thermally actuated brush seals, however, may be compromised by the existing thermal field at, for example, the compressor discharge casing, so as to render the actuation or retraction of the brush seals ineffective or inconsistent.

There is thus a desire for improved systems and methods for retracting a brush seal particularly during transient operations. Such systems and methods should improve the lifetime of the brush seal while also improving overall system operation and efficiency.

### SUMMARY OF THE INVENTION

The present application thus provides a magnetic brush seal system for use with a rotating component and a stationary component. The magnetic brush seal system may include a brush seal for engagement with the rotating component and a magnetic system positioned about the stationary component. The magnetic system may be in communication with the brush seal so as to retract the brush seal from the rotating component.

The present application further provides a method of operating a magnetic brush seal system in a turbine engine. The method includes the steps of positioning the magnetic brush seal system between a stationary component and a rotating component of the turbine engine, engaging the rotating component with the a brush seal of the magnetic brush seal system when the turbine engine is operating a steady state, and activating an electromagnet in the magnetic brush seal system when the turbine engine is operating in a transient state so as to disengage the brush seal from the rotating component.

The present application further provides a magnetic brush seal system for use with a rotor of a turbine. The magnetic brush seal system may include a brush seal for engagement with the rotor, a spring cushioner in communication with the brush seal, and a pair of magnets positioned about the brush seal. The pair of magnets are in communication with the brush seal so as to retract the brush seal from the rotor

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine engine.

FIG. 2 is a schematic view of a magnetic brush seal system as is described herein.

### DETAILED DESCRIPTION

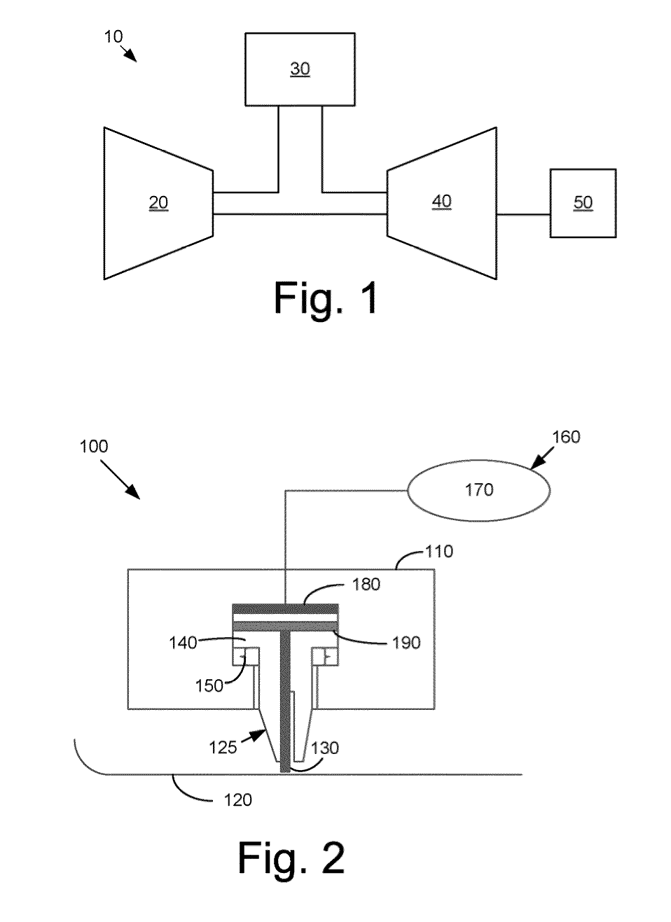

Referring now to the drawings, in which like numbers refer to like elements throughout the several views, FIG. 1 shows a schematic view of a gas turbine engine 10. As is known, the gas turbine engine 10 may include a compressor 20 to compress an incoming flow of air. The compressor 20 delivers the compressed flow of air to a combustor 30. The combustor 30 mixes the compressed flow of air with a compressed flow of fuel arid ignites the mixture. (Although only a single combustor 30 is shown, the gas turbine engine 10 may include any number of combustors 30). The hot combustion gases are in turn delivered to a turbine 40. The hot combustion gases drive the turbine 40 so as to produce mechanical work. The mechanical work produced in the turbine 40 drives the compressor 20 and an external load 50 such as an electrical generator and the like. The gas turbine engine 10 may use natural gas, various types of syngas, and other types of fuels.

The gas turbine engine 10 may be a 9FA Turbine or a similar device provided by General Electric Company of Schenectady, N.Y. Other types of gas turbine engines may be used herein. The gas turbine engine 10 may have other configurations and may use other types of components. Multiple gas turbine engines 10, other types of turbines, and other types of power generation equipment may be used herein together.

FIG. 2 shows a magnetic brush seal system 100 as is described herein. As described above, the magnetic brush seal system 100 seals between a stationary component 110 such as a sealing ring and a rotating component 120 such as a rotor and the like. Other configurations may be used herein. The stationary component 110 also may include a number of labyrinth seals or similar types of seals positioned thereon as well.

The magnetic brush seal system 100 includes a brush seal 125. The brush seal 125 may include a number of bristles 130 positioned between a pair of backing plates 140. The bristles 130 may extend beyond the backing plates 140 and into engagement with the surface of the rotating component 120. The bristles 130 may be made of metal or other materials such as ceramics. Any number or size of the bristles 130 may be used.

The magnetic brush seal system 100 further includes one or more spring cushioners 150 positioned about the backing plates 140 of the brush seal 125. The spring cushioners 150 may be made out of Inconel 718 or similar types of materials. (Inconel 718 is a nickel chromium alloy made precipitation hardenable by additions of aluminum and titanium and having creep rupture strength at high temperatures to about 1290 degrees Fahrenheit (about 700 degrees Celsius)). Such a material may have about a seventeen percent stress relaxation at such high temperatures. Inconel is a trademark of Huntington Alloys Corporation of Huntington, W.Va. Other types or combinations of materials may be used herein. The stiffness and length of the spring cushioners 150 may be varied.

The magnetic brush seal system 100 also may include a magnetic system 160. The magnetic system 160 may include a power source 170. The power source 170 may be any type of conventional DC based current system. The magnetic system 160 also may include an electromagnet 180 positioned about the stationary component 110. The electromagnet 180 may be of conventional design. The electromagnet 180 may produce a magnetic field when the power source 170 is turned on. The magnetic field may be varied.

The magnetic system 160 further may include a permanent magnet 190. The permanent magnet 190 may be positioned about the bristles 130 and the backing plates 140 of the brush seal 125. The permanent magnet 190 may be any type of ferromagnetic material. The permanent magnet 190 may be attracted to the electromagnet 180 when the electromagnet 180 is activated. The nature of the attraction may be varied. The position of the magnets 180, 190 may be varied. Other types of attraction means may be used herein.

In use, the spring cushioners 150 maintain the bristles 130 of the brush seal 125 in positioned about the rotating component 120 during steady state operations. The weight of the brush seal 125 should be able to overcome the stiffness of the spring cushioners 150 and the contact stiffness of the bristles 130 so at to keep the bristles 130 in contact with the rotating component 120.

During transient operations, however, the power source 170 of the magnetic system 160 may energize the electromagnet 180 such that the permanent magnet 190 is attracted thereto. The magnetic attraction lifts the bristles 130 of the brush seal 125 off of the rotating component 120 so as to avoid or minimize damage therewith. The magnetic system 160 may be de-energized once steady state operations are again achieved. The strength of the electromagnet 180 may be balanced with the stiffness of the spring cushioners 150 and the overall weight of the brush seal 125 so as to provide the appropriate gap with the rotating component 120 or otherwise.

The magnetic brush seal system 100 thus improves the longevity of the bristles 130 of the brush seal 125. The magnetic brush seal system 100 also may provide for stricter control of purge flows and also may help to minimize parasitic flows. The magnetic brush seal system 100 also does not interfere with the existing thermal field so as to provide for consistent operation.

It should be apparent that the foregoing relates only to certain embodiments of the present application, and that numerous changes and modifications may be made herein by one of ordinary skill in the art without departing from the general spirit and scope of the invention as defined by the following claims and the equivalents thereof.

We claim:

1. A magnetic brush seal system for use with a rotating component, and a stationary component, comprising;
a brush seal for engagement with the rotating component; and
a magnetic system positioned about the stationary component, and in communication with the brush seal so as to retract the brush seal from the rotating component.

2. The magnetic brush seal system of claim 1, wherein the brush seal comprises a plurality of bristles positioned about a backing plate.

3. The magnetic brush seal system of claim 2, wherein the brush seal comprises a pair of backing plates.

4. The magnetic brush seal system of claim 1, further comprising a spring cushioner positioned about the brush seal.

5. The magnetic brush seal system of claim 4, wherein the spring cushioner comprises a nickel chromium alloy.

6. The magnetic brush seal system of claim 4, wherein the spring cushioner comprises a variable stiffness.

7. The magnetic brush seal system of claim 1, wherein the magnetic system comprises an electromagnet and a permanent magnet.

8. The magnetic brush seal system of claim 7, wherein the magnetic system comprises a power source in communication with the electromagnet.

9. The magnetic brush seal system of claim 7, wherein the electromagnet comprises a variable field,

10. The magnetic brush seal system of claim 7, wherein the magnetic system retracts the brush seal when the magnetic system is activated.

11. The magnetic brush seal system of claim 1, wherein the rotating component comprises a rotor.

12. A method of operating a magnetic brush seal system in a turbine engine, comprising:
positioning the magnetic brush seal system between a stationary component and a rotating component of the turbine engine;
engaging the rotating component with the a brush seal of the magnetic brush seal system when the turbine engine is operating a steady state; and
activating an electromagnet in the magnetic brush seal system when the turbine engine is operating in a transient state so as to disengage the brush seal from the rotating component.

13. A magnetic brush seal system for use with a rotor of a turbine, comprising:
a brush seal for engagement with the rotor;
a spring cushioner in communication with the brush seal; and
a pair of magnets positioned about the brush seal so as to retract the brush seal from the rotor.

14. The magnetic brush seal system of claim 13, wherein the brush seal comprises a plurality of bristles positioned about a backing plate.

15. The magnetic brush seal system of claim 14, wherein the brush seal comprises a pair of backing plates.

16. The magnetic brush seal system of claim 13, wherein the spring cushioner comprises a nickel chromium alloy.

17. The magnetic brush seal system of claim 13, wherein the spring cushioner comprises a variable stiffness.

18. The magnetic brush seal system of claim 13, wherein the pair of magnets comprises a permanent magnet.

19. The magnetic brush seal system of claim 13, wherein the pair of magnets comprises an electromagnet such that the pair of magnets retracts the brush seal from the rotor when the electromagnet is activated.

20. The magnetic brush seal system of claim 19, wherein the electromagnet comprises a variable field.
